(19) United States
(12) Patent Application Publication
(10) Pub. No.: US 2006/0241300 A1
(43) Pub. Date: Oct. 26, 2006

(54) Phosphazenium salt mixtures containing hexakis(amino)diphosphazenium, tetrakis(amino)-phosphonium and polyaminophosphazenium salts

(76) Inventors: Thomas Wessel, Niederdorfelden (DE); Daniel Decker, Liederbach (DE); Thomas Sommer, Ubstadt-Weiher (DE); Hagen Huenig, Dresden (DE); Reinhard Schwesinger, Merzhausen (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/546,502

(22) PCT Filed: Feb. 11, 2004
(86) PCT No.: PCT/EP04/01253

§ 371 Date: May 22, 2006

(30) Foreign Application Priority Data
Feb. 21, 2003 (DE) 103075585

(51) Int. Cl. B01J 31/00; C07F 9/02

(52) U.S. Cl. 546/21; 502/150; 502/162; 502/167; 564/12

(57) ABSTRACT

The invention relates to mixtures containing 5 to 99.5 wt. % of a compound of formula (I), 95 to 0.5 wt. % of a compound of formula (II) and a maximum of 10 wt. % of one of several compounds of general formula (III a), wherein A¹-A³² which are independent from each other are equal or different and represent a straight-chained or branched alkyl or alkenyl having 1-12 carbon atoms, cycloalkyl having 48 carbon atoms, an aryl having 6-12 carbon atoms, an aralkyl having 7-12 carbon atoms, or A¹-A², A³-A⁴, A⁵-A⁶ etc. -A³¹-A³² which are independent from each other and are equal or different and are connected together directly or via O or N-A³³ to a ring having 3-7 ring members, A³³ represents an alkyl having 1-4 carbon atoms. X₁ and/or X₂ and/or X₃ which are independent from each other represent a radical of formula (III b), or the radical X1 and/or X₂ and/or X₃ as well as a straight-chained or branched alkyl or alkenyl having 1-12 carbon atoms, cycloalkyl having 4-8 carbon atoms represent an aryl having 6-12 carbon atoms, an aralkyl having 7-12 carbon atoms, or respectively the radicals which are disposed on an identically bound nitrogen atom, e.g. A¹ and A², A³ and A⁴, A⁵ and A⁶ etc. -A³¹ and A³² which are independent from each other are equal or different and are connected together directly or via O or N-A³³ to a ring having 3-7 ring members and A³³ represents an alkyl having 1-4 carbon atoms and B⁻ represents a single-valent organic or inorganic acid radical or the equivalent of a multi-valent acid radical. The mixtures can be used as catalysts and co-catalysts for phase transfer reactions, nucleophilic substitution reactions or halogen-fluoro-exchange reactions.

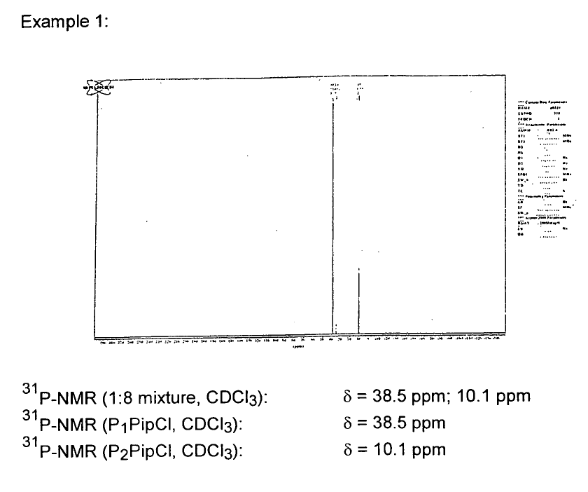

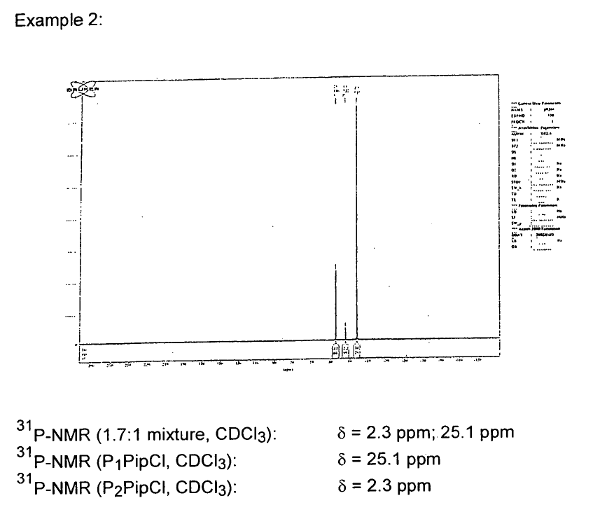

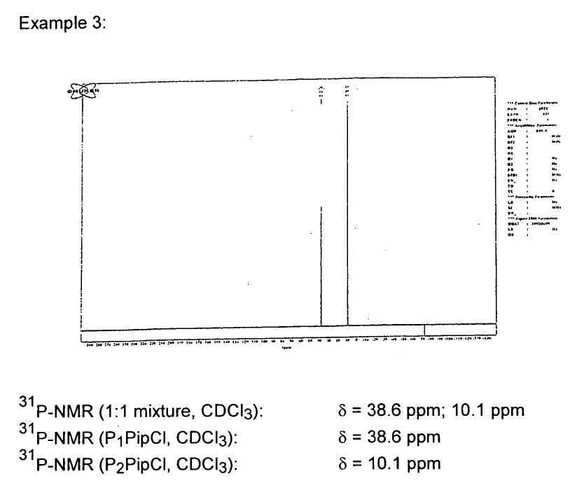

The present invention relates to aminophosphazenium salt mixtures, a process for preparing them and their use as catalysts for phase transfer reactions, nucleophilic substitution reactions or halogen-fluorine exchange reactions.

Aminophosphonium salts and polyaminophosphazenium salts are, as described, for example, in U.S. Pat. No. 5,824,827, EP-A-1 070 723, EP-A-1 070 724 and EP-A-1 266 904, employed as catalysts in the preparation of fluorine-containing compounds by means of a halogen exchange reaction (halex reaction).

Although the aminophosphonium salts mentioned in U.S. Pat. No. 5,824,827 and EP-A-1 070 723 and mixtures in which these are present (EP-A-1 070 724) give good results in the catalysis of halex reactions, they are less active catalysts than polyaminophosphazenium salts. However, the syntheses known to date for polyaminophosphazenium compounds are very complicated and associated with disadvantages, so that their industrial use has hitherto not been viable.

According to R. Schwesinger et al., Liebigs Ann. 1996, 1055-1081, the preparation and isolation of pure hexakis(amino)diphosphazenium salts is carried out, for example, by firstly reacting phosphorus pentachloride with a secondary amine to produce a chlorotrisaminophosphonium salt and then reacting this with a tris(amino)phosphorimine to give hexakis(amino)-diphosphazenium chloride. The phosphorimine has to be prepared beforehand by reaction of the chlorotrisaminophosphonium salt with ammonia and subsequent treatment with potassium methoxide in methanol.

A variant which is simpler than that described by R. Schwesinger et al. concerns the synthesis of hexakis(dimethylamino)diphosphazenium tetrafluoroborate (Angew. Chem. 103 (1991), 1376, and Angew. Chem. 104 (1992), 864) and comprises reacting phosphorus pentachloride with ammonium chloride and subsequently reacting the product with dimethylamine and sodium tetrafluoroborate in nitromethane (CH₃NO₂) or phosphorus oxychloride (POCl₃).

The higher homologous polyaminophosphazenium salts are prepared via multistage syntheses (cf. R. Schwesinger et al., Liebigs Ann. 1996, 1055-1081) by, for example, firstly synthesizing an iminotrisaminophosphorane from phosphorus pentachloride by reaction with a secondary amine, addition of ammonia and subsequent treatment with potassium methoxide in methanol and then reacting this with an alkyliminophosphorus trichloride which has been prepared beforehand from the corresponding alkylammonium chloride by reaction with a mixture of PCl₅ and PCl₃.

These synthetic methods are associated with a series of disadvantages: when nitromethane is used as solvent, explosive nitromethane/amine mixtures are formed in the synthesis, so that nitromethane is ruled out as solvent for the synthesis of aminophosphazenium salts for safety reasons. The use of phosphorus oxychloride (POCl₃) as solvent for the synthesis of hexakis(dimethylamino)diphosphazenium tetrafluoroborate has the disadvantage that it reacts with the dimethylamine to form hexamethyl-phosphoramide (HMPT) as undesirable carcinogenic by-product. Furthermore, the industrial-scale use of POCl₃ as solvent is greatly restricted because of its toxicity (classification: T+) and requires additional occupational hygiene measures and additional measures in the design of industrial plants.

In view of the abovementioned restrictions and disadvantages from which the aminophosphazenium syntheses described suffer, there is a great need for a simple and inexpensive process for preparing polyamino-phosphazenium salts or mixtures in which these are present, which reduces the use of toxic solvents and starting materials to that which is absolutely necessary, avoids the formation of carcinogenic by-products as far as possible and leads to catalysts for the halex reaction which have a catalytic activity comparable to that of the pure polyaminophosphazenium salts and also makes the complicated separation of the individual components superfluous.

This object is achieved by a process for preparing aminophosphazenium mixtures comprising from 5 to 99.5% by weight, in particular from 10 to 95% by weight, preferably from 20 to 80% by weight, of a compound of the formula (I), from 95 to 0.5% by weight, in particular from 90 to 5% by weight, preferably from 80 to 20% by weight, of a compound of the formula (II) and not more than 10% by weight, preferably a maximum of 8% by weight, particularly preferably not more than 5% by weight, of one or more compounds of the formula (III a)

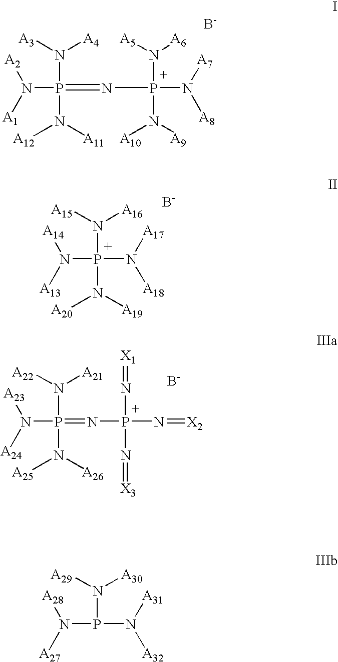

where A¹ to A³² are identical or different and are each, independently of one another, a straight-chain or branched alkyl or alkenyl having from 1 to 12 carbon atoms, a cycloalkyl having 4-8 carbon atoms, an aryl having from 6 to 12 carbon atoms, an aralkyl having 7-12 carbon atoms, or A¹-A², A³-A⁴, A⁵-A⁶, etc., to A³¹-A³² are identical or different and are each, independently of one another, joined to one another either directly or via O or N-A³³ to form a ring having from 3 to 7 ring atoms and A³³ is an alkyl having from 1 to 4 carbon atoms, where X₁ and/or X₂ and/or X₃ are, independently of one another, radicals of the formula (III b), or the radicals X₁ and/or X₂ and/or X₃ are likewise each a straight-chain or branched alkyl or alkenyl having from 1 to 12 carbon atoms, a cycloalkyl having from 4 to 8 carbon atoms, an aryl having from 6 to 12 carbon atoms, an aralkyl having from 7 to 12 carbon atoms, or the radicals which are located on an identically bonded nitrogen atom, e.g. A¹ and A², A³ and A⁴, A⁵ and A⁶, etc., to A³¹ and A³² are identical or different and are each, independently of one another joined to one another either directly or via O or N-A³³ to form a ring having from 3 to 7 ring atoms, A³³ is an alkyl having from 1 to 4 carbon atoms and B⁻ is a monovalent organic or inorganic acid radical or the equivalent of a polyvalent acid radical,

wherein a phosphorus pentahalide is reacted firstly with ammonia or an ammonium halide in an inert solvent with removal of hydrogen halide and subsequently with one or more amines of the formula HNA¹A², HNA³A⁴, etc. to HNA³¹A³², where A¹ to A³² are the abovementioned radicals, the reaction product obtained is brought to a pH of from 7 to 15 by means of aqueous caustic alkali, the organic phase and the aqueous phase are separated and the organic phase is concentrated by distillation or trite reaction product is isolated as a solid by complete removal of the solvent.

The present invention further provides the mixtures themselves and provides for their use as catalysts and cocatalysts for phase transfer reactions, nucleophilic substitution reactions or halogen-fluorine exchange reactions.

In the process of the invention, phosphorus pentahalide (PHal₅) is firstly reacted with ammonia or an ammonium halide in a first reaction step, with the ratio of PHal₅ to ammonia or ammonium halide being from 0.5:1 to 5:1. The reaction is carried out at a temperature in the range from 25° C. to 200° C., in an inert solvent with removal of hydrogen halide. The reaction mixture obtained is subsequently reacted with one or more amines of the formula HNA¹A², HNA³A⁴, etc. to HNA³¹A³², where A¹ to A³² are the abovementioned radicals, in a ratio of from 6:1 to 50:1, based on phosphorus pentahalide used, at from −20 to 200° C. in a second reaction step, the reaction product obtained is brought to a pH of from 7 to 15 at from 0 to 80° C. by means of aqueous caustic alkali, the organic phase and the aqueous phase are separated and the organic phase is concentrated by distillation. The product obtained is used directly as a solution or is isolated as a solid by distilling off all of the solvent. If desired, the composition of the reaction product in respect of the individual components can be altered by recrystallization.

In the reaction of phosphorus pentahalide with ammonia or the ammonium halide, a dispersion of various intermediates is formed as primary reaction product, and the amine is usually added to this. The reverse order of addition is likewise possible.

Selection of the ratio of phosphorus pentahalide to ammonia or ammonium halide enables the ratio of the individual phosphazene structures to be determined. A low ratio leads to an increased proportion of the components of the formula IIIa in the product mixture. High temperatures favor the formation of more highly condensed phosphazenium compounds, while short reaction times lead to incomplete reactions and the formation of by-products in the subsequent steps.

In the reaction of the intermediates obtained in the first reaction step with the amine or amines, the heat of reaction is exploited in order to heat the reaction mixture to the reaction temperature. To complete the reaction, the reaction mixture is stirred for a further period of time at the respective final temperature.

After the second reaction step is complete, the reaction product-is treated with aqueous caustic alkali at from 0 to 80° C. The caustic alkali is used in such an amount that a pH of from 7 to 15 is maintained in the treatment. As a result of the treatment with the aqueous caustic alkali, hydrolyzable constituents of the reaction product are liberated and the amine which is used in excess is liberated from the hydrohalides of the amine which are formed in the reaction. The recovered amine can be reused in the reaction.

The aqueous phase is separated from the organic phase which comprises the desired reaction product, the solvent, excess amine and the amine liberated from the hydrohalides of the amine. The organic phase is subsequently concentrated, for example by vacuum distillation, and the residue is used directly or the solvent is distilled off completely and the product is isolated as a solid.

Precipitation by means of a second solvent and filtration of the precipitate gives a product which has a different product composition compared to a product which is obtained by complete removal of the solvent by distillation. The solvent used for precipitation is employed in an amount of from 500 to 5% by weight. If desired, the ratio of the individual components I, II and IIIa in the mixtures can be altered by recrystallization of the reaction product from a further solvent.

In view of the fact that Schwesinger et al. describe the reaction of the hexachlorodiphosphazenium salt obtained from POCl₃ only with the not very bulky dimethylamine, an expert would find it surprising that this reaction is also possible in high selectivity and excellent yields in the case of bulky amines such as piperidine and pyrrolidine (cf. Examples 1 to 3).

It is also notable that, in view of the syntheses described in the literature, the mixtures obtained have a defined composition, i.e. they comprise predominantly two compounds of the formulae I and II. A person skilled in the art would have expected that a multiplicity of products would be formed in the preparation described.

A likewise impressive and unexpected aspect is that the mixtures obtained can be used directly as catalysts or cocatalysts in halex reactions and display an activity comparable to, or in many cases even higher than, for example, the aminophosphonium salts used in U.S. Pat. No. 5,824,827 and the pure polyaminophosphazenium salts used in DE-A-102 32 811.0.

Chemical reactions at high temperatures and long reaction times usually lead to reaction products comprising a multiplicity of by-products which prevent their use as catalyst if a complicated additional purification is not carried out. As a person skilled in the art will know, catalyst poisons act even in very small amounts.

As a result of the sometimes increased activity of the mixtures as catalysts, the reaction temperatures in halex reactions can be reduced and higher selectivities and yields can therefore be achieved.

The reaction of the phosphorus pentahalide with ammonia or the ammonium halide is carried out at from 25° C. to 200° C., preferably from 50 to 150° C., with the hydrogen halide formed being removed during the reaction. The halides used are preferably phosphorus pentachloride, phosphorus pentabromide, ammonium chloride and ammonium bromide. It is likewise possible to prepare the phosphorus pentahalide from the corresponding phosphorus trihalide and the halogen in a preceding reaction step.

In many cases, the phosphorus pentahalide is reacted with ammonia or the ammonium halide in a ratio of from 0.5:1 to 5:1, in particular from 1:1 to 4:1, preferably from 1.5:1 to 3:1.

As inert solvent, use is made of phosphorus oxychloride (POCl₃), an aliphatic, cycloaliphatic or aromatic hydrocarbon or a singly or multiply chlorinated aliphatic, cycloaliphatic or aromatic hydrocarbon.

Well-suited solvents are, for example, phosphorus oxychloride, methylcyclohexane, heptane, octane, toluene, ethylbenzene, mesitylene, o-xylene, m-xylene, p-xylene, industrial mixtures of isomeric xylenes, tetrachloroethane, chlorobenzene, chlorotoluene, dichlorobenzene, dichlorotoluene, in particular POCl₃, toluene, chlorobenzene and dichlorobenzene. It is also possible to use mixtures of solvents. For the second reaction stage, viz. the reaction of the reaction product of phosphorus pentahalide with ammonia or ammonium halide with the amine or amines, suitable solvents are the abovementioned solvents with the exception of phosphorus oxychloride which is not stable under these conditions.

The hydrogen halide formed in the reaction is removed continuously by allowing this to escape from the apparatus, aiding the discharge of the hydrogen halide by passing a stream of inert gas through the apparatus or by applying a slight vacuum.

After the reaction of the phosphorus pentahalide with ammonia or the ammonium halide is complete, the reaction product is reacted with the amine in a ratio of from 6:1 to 50:1, in particular from. 7:1 to 30:1, preferably from 8:1 to 25:1, based on phosphorus pentahalide used.

In particular, the following amines, for example, can be used successfully: dimethylamine, diethylamine, dipropylamine, diisopropylamine, dibutylamine, diisobutylamine, dipentylamine, bis(3-methylbutyl)amine, dihexylamine, bis(2-ethylhexyl)amine, diallylamine, bis(cyclopropylmethyl)-amine, dicyclopentylamine, dicyclohexylamine, bis(4-methylcyclohexyl)-amine, bis(4-tert-butylcyclohexyl)amine, pyrrolidine, piperidine, N-methylpiperazine, N-ethylpiperazine, morpholine,

The addition of the amine and the continuation of the reaction are effected at −20 to 200° C., in particular from 0 to 180° C., preferably from 20 to 160° C.

The continuation of the reaction is particularly simple when it is carried out under reflux conditions and a solvent which has a boiling point in the desired temperature range is chosen.

The reaction is generally carried out under atmospheric pressure, but it can also be carried out under superatmospheric pressure so that it is also possible to use solvents whose boiling point is below the abovementioned temperature range.

After the reaction is complete, the reaction product is, as already mentioned, treated with aqueous caustic alkali at from 0 to 80° C., in particular from 10 to 70° C., preferably from 25 to 50° C., so that a pH of from 7 to 15, in particular from 8 to 14.5, preferably from 9 to 14, is established. A suitable aqueous caustic alkali is, for example, an alkali metal hydroxide or alkaline earth metal hydroxide solution having a concentration of from 5 to 50% by weight, in particular from 15 to 30% by weight, preferably from. 20 to 25% by weight. It is particularly simple to use a corresponding aqueous NaOH or KOH solution.

Subsequent to the treatment of the reaction product with the caustic alkali, the aqueous phase is separated off from the organic phase. The mixtures of the compounds of the formulae I, II and IIIa are present in the organic phase.

Partial or complete removal of the volatile constituents, encompassing the solvent, excess amine and the amine liberated from the hydrohalides of the amine, gives solutions of the mixtures or the mixture in the form of a solid. Addition of a second solvent in which one or more components I, II, IIIa have a reduced solubility enables part of the product mixture to be precipitated and a product having a different product composition compared to the starting mixture to be obtained. If desired, the relative proportions of the individual components of the mixtures can be altered further by further recrystallization of the product.

It is also possible to replace the anion B⁻═Cl⁻ or Br⁻ by other monovalent organic or inorganic acid radicals or equivalents of a polyvalent acid radical. In this case, B⁻ is F⁻, I⁻, ClO₄⁻, BF₄⁻, PF₆⁻, NO₃⁻, HSO₄⁻, ½SO₄²⁻, H₂PO₄⁻, ½HPO₄²⁻, ⅓PO₄³⁻, R¹—COO—, where R¹ is an alkyl radical having from 1 to 9 carbon atoms, a phenyl radical, benzyl radical or naphthyl radical, R²—SO₃⁻, where R² is an alkyl radical having from 1 to 18 carbon atoms, a phenyl radical, tolyl radical or naphthyl radical, HCO₃⁻, ½CO₃²⁻, ½C₆H₄(COO⁻)₂, CN⁻, R¹O⁻, where R¹ is as defined above. B⁻ is in particular F⁻, Cl⁻, Br⁻, I⁻, BF₄⁻, PF₆⁻ or ½SO₄²⁻, preferably F⁻, Cl⁻, Br⁻ for use as halex catalysts.

The invention further provides for the use of the abovementioned mixtures comprising compounds of the formulae I, II and IIIa as catalyst or cocatalyst for phase transfer reactions, nucleophilic substitutions or halex reactions, in particular for phase transfer reactions and halex reactions, preferably for halex reactions.

### EXAMPLE 1

750 ml of chlorobenzene are placed under argon in a 4 l flange flask and 208.3 g (1.0 mol) of PCl₅ and 36.0 g (0.67 mol) of NH₄Cl are introduced in succession. The reaction mixture is slowly heated to 105° C. and maintained at 105° C. until no gas evolution is detected. The hydrogen chloride liberated in the reaction is removed continuously via an offgas line and absorbed in water.

The mixture is subsequently cooled to 20° C. and 1920 g (22.5 mol) of piperidine are introduced while cooling at such a rate that the internal temperature does not exceed 50° C. After the addition is complete, the mixture is heated to reflux and refluxed for 22 hours. After the reaction is complete, the mixture is cooled to 40° C. and 700 g of 20% strength aqueous sodium hydroxide solution are added. The organic phase is separated off and evaporated to dryness on a rotary evaporator. Piperidine is redistilled from the distillate and is used again.

The solid which has been isolated is dried and examined by ³¹P-NMR spectroscopy. According to this, the mixture comprises 1,1,1,3,3,3-hexakis(piperidino)diphosphazenium chloride (P₂PipCl) and tetrakis(piperidino)phosphonium chloride (P₁PipCl) in a ratio of 1:8.

### EXAMPLE 2

250 ml of toluene are placed under argon in a 2 l flange flask and 104.5 g (0.5 mol) of PCl₅ and 9.5 g (0.18 mol) of NH₄Cl are introduced in gas evolution has ceased. The hydrogen chloride liberated in the reaction is removed continuously via an offgas line. The mixture is subsequently cooled to 20° C. and 355.5 g (5 mol) of pyrrolidine are added while cooling at such a rate that the internal temperature does not exceed 40° C. After the addition is complete, the mixture is heated to reflux and refluxed for 22 hours. After the reaction is complete, the mixture is cooled to 40° C. and 350 g of a 20% strength aqueous sodium hydroxide solution are added. The organic phase is separated off and evaporated to dryness on a rotary evaporator. The solid obtained is recrystallized from a mixture of toluene and THF in a ratio of 5:1. This gives 81 g of a 1.7:1 mixture of 1,1,1,3,3,3-hexakis(pyrrolidino)diphosphazenium chloride (P₂PyrCl) and tetrakis(pyrrolidino)phosphonium chloride (P₁PyrCl).

### EXAMPLE 3

1000 ml of POCl₃ are placed under argon in a 4 l flange flask and 208.3 g (1 mol) of PCl₅ and 17.65 g (0.33 mol) of NH₄Cl are introduced in succession. The reaction mixture is slowly heated to reflux and stirred until gas evolution has ceased. The hydrogen chloride liberated in the reaction is removed continuously via an offgas line. POCl₃ used is subsequently distilled off as completely as possible and replaced by 2000 ml of chlorobenzene. The reaction mixture is cooled to 20° C., admixed with 1277 g (15 mol) of piperidine by cooling in ice and stirred at 40° C. for 4.5 days. After the reaction is complete, excess piperidine is distilled off and the concentrated reaction mixture is hydrolyzed by means of 900 g of 22.5% strength aqueous sodium hydroxide solution. The phases are separated and the organic phase is concentrated by distillation. Addition of 500 ml of tetrahydrofuran gives a precipitate which is filtered off with suction and dried under reduced pressure. This gives 270 g of a mixture of 1,1,1,3,3,3-hexakis(piperidino)diphosphazenium chloride (P₂PipCl) and tetrakis(piperidino)phosphonium chloride (P₁PipCl) in a ratio of 1:1.

### EXAMPLE 4

Preparation of 2,6-difluorobenzaldehyde from 2-chloro-6-fluorobenzaldehyde by means of chlorine-fluorine exchange reaction using a 1:1 mixture of 1,1,1,3,3,3-hexakis(piperidino)diphosphazenium chloride (P₂PipCl) and tetrakis(piperidino)phosphonium chloride (P₁PipCl).

4.63 g of a 1:1 mixture (corresponding to 9.5 mmol of catalyst) of 1,1,1,3,3,3-hexakis(piperidino)diphosphazenium chloride and tetrakis(piperidino)phosphonium chloride, 92.1 g of potassium fluoride (1.57 mol) and 39.5 g of chlorobenzene are added in succession to 277.5 g of 2-chloro-6-fluorobenzaldehyde (1.75 mol). The reaction mixture is dried azeotropically by distillation under reduced pressure. It is then brought to 190° C. and maintained at this temperature for 24 hours. Gas-chromatographic analysis of the reaction mixture finds 24.6% of 2-chloro-6-fluorobenzaldehyde and 75.2% of 2,6-difluorobenzaldehyde.

### COMPARATIVE EXAMPLE 4a:

Preparation of 2,6-difluorobenzaldehyde from 2-chloro-6-fluorobenzaldehyde by means of a chlorine-fluorine exchange reaction using tetrakis(piperidino)phosphonium chloride (P₁PipCl) or 1,1,1,3,3,3-hexakis(piperidino)diphosphazenium chloride (P₂PipCl) as catalyst:

9.5 mmol of catalyst, 92.1 g of potassium fluoride (1.57 mol) and 39.5 g of chlorobenzene are added in succession to 277.5 g of 2-chloro-6-fluoro-benzaldehyde (1.75 mol). The reaction mixture is dried azeotropically by distillation under reduced pressure. It is then brought to 190° C. and maintained at this temperature for 24 hours. The reaction mixture is analyzed by gas chromatography. The following conversions were obtained:

| | 2-Chloro-6-fluorobenzaldehyde | 2,6-Difluorobenzaldehyde |
|---|---|---|
| P₁PipCl | 38.4% | 61.6% |
| P₂PipCl | 10.2% | 88.5% |
| P₁PipCl/ | 24.6% | 75.2% |
| P₂PipCl | | |

### COMPARATIVE EXAMPLE 5

Preparation of 2,3,4,5,6-pentafluoropyridine from 3,5-dichloro-2,4,6-trifluoropyridine by means of a chlorine-fluorine exchange reaction using tetrakis(piperidino)phosphonium chloride (P₁PipCl), 1,1,1,3,3,3-hexakis(pyrrolidino)diphosphazenium chloride (P2PyrCl) or a 1:1 mixture of P₁PipCl and P2PipCl as phase transfer catalysts:

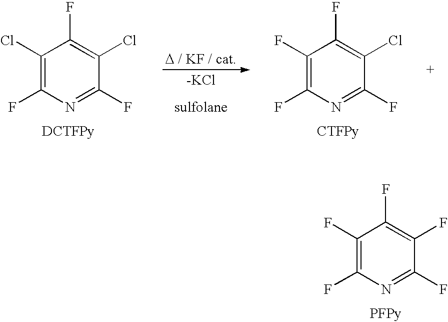

11 mmol of catalyst, 38.3 g of potassium fluoride (0.66 mol) and 50 g of chlorobenzene are added in succession to 135 g of molten sulfolane. The reaction mixture is dried azeotropically by distillation under reduced pressure. 44.4 g of 3,5-dichloro-2,4,6-trifluoropyridine are then added and the mixture is heated at 190° C. in a closed stirring autoclave and maintained at this reaction temperature for. 24 hours. The reaction mixture is analyzed by gas chromatography. The following conversions were obtained

| | | | | P₁PipCl/P₂PipCl | |
|---|---|---|---|---|---|
| P₁PipCl | | P₂PyrCl | | mixed catalyst | |
| DCTFPy: | 57.5% | DCTFPy: | 32.0% | DCTFPy: | <0.5% |
| CTFPy: | 42.0% | CTFPy: | 60.8% | CTFPy: | 29.8% |
| PFPy: | <0.5% | PFPy: | 7.2% | PFPy: | 69.5% |

1. A mixture comprising from 5 to 99.5% by weight of a compound of the formula (I), from 95 to 0.5% by weight of a compound of the formula (II) and not more than 10% by weight of one or more compounds of the formula (III a) 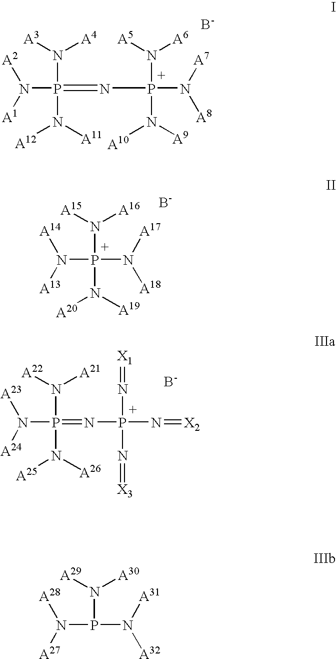
where radicals A¹ to A³² are identical or different and are each, independently of one another, a straight-chain or branched alkyl or alkenyl having from 1 to 12 carbon atoms, a cycloalkyl having from 4 to 8 carbon atoms, an aryl having from 6 to 12 carbon atoms, an aralkyl having from 7 to 12 carbon atoms, or radicals Aⁿ-Aⁿ⁺¹ where n is 1 to 31 and which are located on an identically bonded nitrogen atom are identical or different and are each, independently of one another, joined to one another either directly or via O or N-A³³ to form a ring having from 3 to 7 ring atoms, A³³ is an alkyl having from 1 to 4 carbon atoms, where X₁, X₂, and X₃ are, independently of one another, radicals of the formula (III b), or the radicals X₁, X₂, and X₃ are likewise each a straight-chain or branched alkyl or alkenyl having from 1 to 12 carbon atoms, a cycloalkyl having from 4 to 8 carbon atoms, an aryl having from 6 to 12 carbon atoms, an aralkyl having from 7 to 12 carbon atoms, or the radicals Aⁿ-Aⁿ⁺¹ where n is 1 to 31 and which are located on an identically bonded nitrogen atom, are identical or different and are each, independently of one another joined to one another either directly or via O or N-A³³ to form a ring having from 3 to 7 ring members and A³³ is an alkyl having from 1 to 4 carbon atoms and B⁻ is a monovalent organic or inorganic acid radical or the equivalent of a polyvalent acid radical.

2. A mixture as claimed in claim 1 comprising from 10 to 95% by weight of a compound of the formula I, from 90 to 5% by weight of a compound of the formula II and not more than 8% by weight of compounds of the formula III a.

3. A mixture as claimed in claim 1 comprising from 20 to 80% by weight of a compound of the formula I, from 80 to 20% by weight of a compound of the formula II and not more than 5% by weight of compounds of the formula III a.

4. A process for preparing the mixture of claim 1, said process comprising:
a) reacting a phosphorus pentahalide with ammonia or an ammonium halide in a ratio of from 0.5:1 to 5:1 at from 25° C. to 200° C. in an inert solvent with removal of hydrogen halide to provide an intermediate reaction product;
b) subsequently reacting the intermediate reaction product with one or more amines of the formula HNAⁿAⁿ⁺¹, where n is 1 to 31, in a ratio of from 6:1 to 50:1, based on phosphorus pentahalide used at from −20 to 200° C. to provide a reaction product;
c) adjusting reaction product pH to 7 to 15 at from 0 to 80° C. with aqueous caustic alkali to provide an organic phase and an aqueous phase,
d) separating the organic phase and the aqueous phase; and
e) concentrating the organic phase by distillation to provide said mixture.

5. The process as claimed in claim 4, wherein in step (a) the inert solvent is selected from the group consisting of phosphorus oxychloride, an aliphatic hydrocarbon, a cycloaliphatic hydrocarbon, an aromatic hydrocarbons, a singly chlorinated aliphatic, cycloaliphatic, or aromatic hydrocarbon, a multiply chlorinated aliphatic, cycloaliphatic or aromatic hydrocarbon, and mixtures thereof.

6. The process of claim 4, wherein step (b) takes place in the presence of a second solvent selected from the group consisting of an aliphatic hydrocarbon, a cycloaliphatic hydrocarbon, an aromatic hydrocarbon, a singly chlorinated aliphatic, cycloaliphatic or aromatic hydrocarbon, a multiply chlorinated aliphatic, cycloaliphatic or aromatic hydrocarbon, and mixtures thereof.

7. The process of claim 4, wherein the ratio of phosphorus pentahalide to ammonia or ammonium halide is from 1:1 to 4:1.

8. The process of claim 4, wherein the intermediate reaction product in step (b) is reacted with amine in the ratio of from 7:1 to 30:1.

9. A method for catalyzing a reaction selected from the group consisting of phase transfer reactions, nucleophilic substitution reactions, halogen-fluorine exchange reactions, and combinations thereof, said method comprising adding to said reaction the mixture of claim 1.
